(19) United States
(12) Patent Application Publication
(10) Pub. No.: US 2009/0178328 A1
(43) Pub. Date: Jul. 16, 2009

(54) Air cannon bait shooter

(75) Inventor: Kenneth E. Jelnicki, JR., Browns Mills, NJ (US)

Correspondence Address: Arthur M. Peslak, Esq.;Mandel & Peslak, LLC, Suite 5, 80 Scenic Drive, Freehold, NJ, 07728-5211, US

(73) Assignee: Surf Rocket, LLC

(21) Appl. No.: 12/008,738

(22) Filed: Jan. 14, 2008

(51) Int. Cl. A01K 91/02; F41B 11/06; A01K 97/00

(52) U.S. Cl. 43/19; 124/74

(57) ABSTRACT

A device to be used to propel a hook, weighted lure or popping cork is disclosed. The device is intended to be used with a conventional fishing rod and reel. The device comprises a storage vessel for compressed air, a valve for releasing the air, and an elongated tube adapted to receive the weighted hook, lure with water or popping cork. In addition, the present invention is particularly adapted to be used with a baited hook, weighted and frozen in a block of ice.

### BACKGROUND OF THE INVENTION

The present invention is directed to the field of fishing and in particular to a device used to aid a fisherman who is surf fishing from the beach. In general, fishermen who are fishing from the beach will cast their baited hook, lure or rope with popping cork manually into the surf. This process limits how far the baited hook can be projected from the shore into the water. Often times a large number of fish may be present several hundred feet off shore which is generally beyond the capability for manual casting.

The existing solutions to assist a fisherman in casting further into the surf have suffered from various defects. None of the prior devices provide a simple easy to transport and use device for a fisherman to use to propel the baited hook far into the surf.

### SUMMARY OF THE INVENTION

The present invention is directed to a device for propelling a baited fishing hook, lure or rope popping cork that is attached to a fishing rod and reel, wherein the device comprises a storage vessel for compressed gas and an outlet port, a valve connected to the outlet port which is adapted to release the compressed gas from the storage vessel when the valve is opened and an elongated tube connected to the outlet port that is adapted to receive the baited fishing hook.

### BRIEF DESCRIPTION OF THE DRAWINGS

FIG. 1 is a plan view of the present invention illustrating an embodiment of the present invention in conjunction with a fishing rod.

FIG. 2 is a plan view illustrating a view of a component of the present invention.

FIG. 3 is a plan view illustrating a component of the present invention.

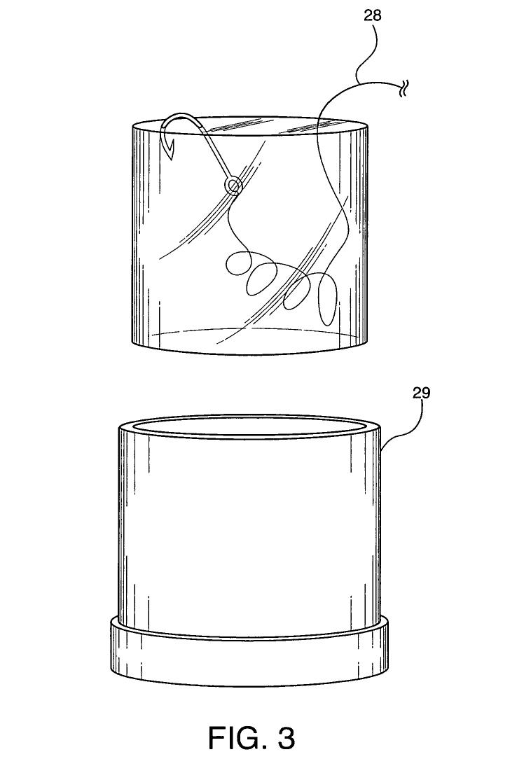

FIG. 4 is a plan view illustrating a component of the present invention.

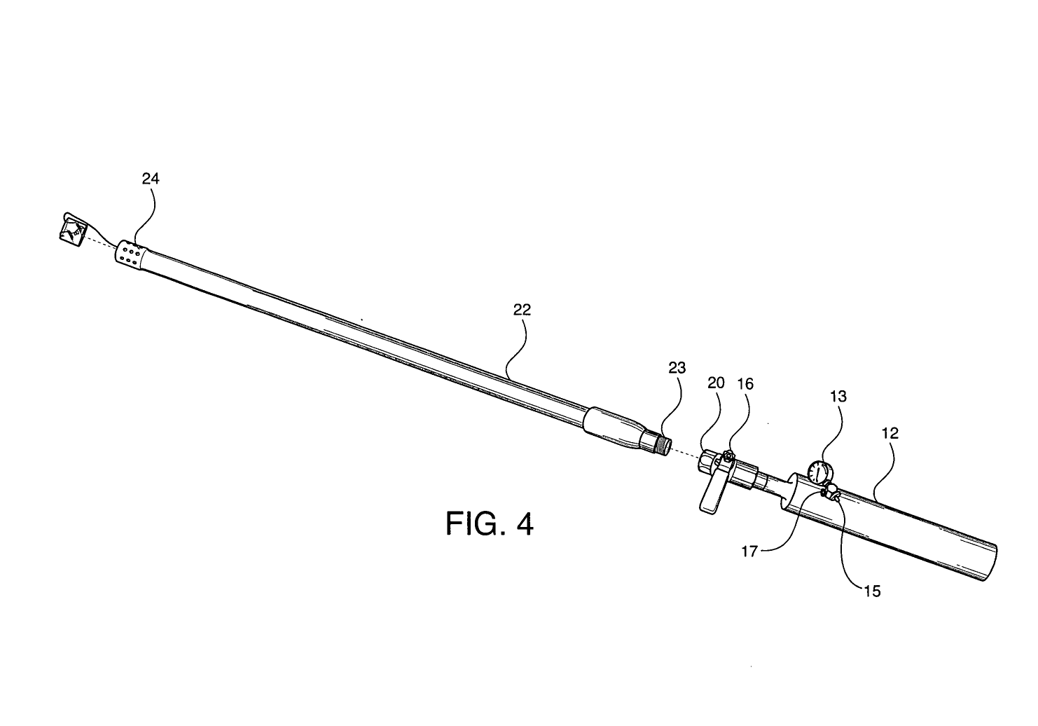

### DETAILED DESCRIPTION OF THE PRESENT INVENTION

The present invention will now be described in terms of the presently preferred embodiment thereof. Those of ordinary skill in the art will recognize that many obvious modifications may be made thereto without departing from the spirit or scope of the present invention.

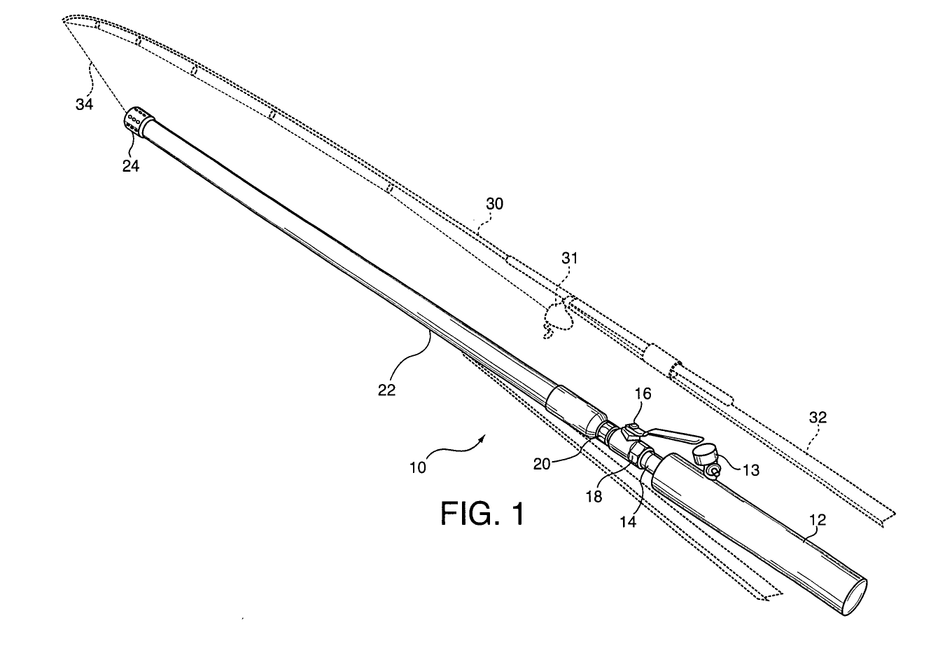

The air cannon 10 of the present invention is illustrated in FIG. 1. The air cannon 10 comprises a refillable tank 12 which contains compressed air. The tank 12 comprises a pressure gauge 13 and an outlet port 14, a refill port 15 and a safety blow off valve 17. In order for the present invention to work as intended, the compressed air in the tank 12 should be filled to a pressure in the range of about 40 to about 100 psi. The tank 12 holds enough air for one cast and must be refilled after each use. With each cast, the user will release the entire amount of compressed air that the tank 12 holds.

A manually operated valve 16 with an inlet port 18 and an outlet port 20 is also provided. The inlet port 18 of the valve 16 is connected to the outlet port 14 of the tank 12. The outlet port 20 of the valve 16 is connected to an elongated tube 22. In the embodiment shown in FIG. 1, the elongated tube 22 is provided with external threads 23 which mate with threads in the outlet port 20.

The elongated tube 22 is open on both ends. A perforated fitting 24 can be provided on one end of the tube 22. The perforated fitting 24 serves to suppress the sound of the air as the air is released from the tank 12.

In order to facilitate far travel of the baited hook from the air cannon 10, the baited hook, lure or rope with popping cork must have substantial weight. In order to provide substantial weight to the system beyond the available sinkers used by fishermen, the present invention further comprises a novel method of preparing the baited hook.

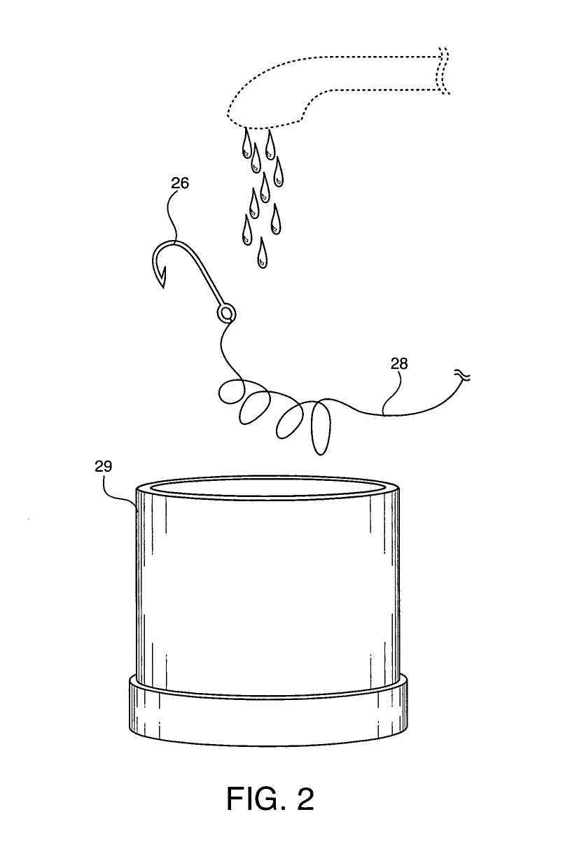

As illustrated in FIG. 2, the hook 26 is provided with conventional bait such as clams, worms etc. The hook 26 is connected to a leader with a swivel 28. The hook 26 with a swivel and weighted sinker thereon is placed into a cylindrical container 29. The container 29 is then filled with water and the entire assembly is then frozen thus creating a large block of ice around the hook 26, with the swivel 28 on the end of the leader extending outside of the ice block.

As illustrated in FIG. 1, a conventional fishing rod 30 and reel 31 are utilized with the present invention. The rod 30 can be held by a fishing partner. The air cannon 10 will be held by the fisherman or rested on a stand 32. When using the frozen bait, the container 29 is first removed from the ice block. The leader 28 will be connected to the fishing line 34 extending from the reel by way of snap swivel or knot. The baited hook 26 with ice block will be placed in the opening at the end of the elongated tube 22 which may have a perforated fitting 24 and will then extend down to the other end of the tube 22. After the baited hook 26 is placed in the tube 22, the reel 31 will be unlocked so that the fishing line 34 can be extended therefrom. At this point, the manually operated valve 16 will be opened releasing all of the compressed air from the tank 12. Due to the high pressure of the air in the tank 12, the baited hook 26 will be propelled up the tube 22 and out into the surf a distance of several hundred feet. Due to the weight and surface area of the ice, the hook and ice block are propelled farther then merely a baited hook could be propelled. The fishermen can vary the distance or direction of flight by moving the tube 22 up or down or to the left or right. In addition, the fisherman can also vary the amount of pressure in the tank 12 and how fast valve 16 is opened to release the air. After the baited hook 26 reaches the water, the ice will melt and fall off the bait and normal fishing will take place.

If the fisherman desires to use a lure rather than a baited hook, the air cannon 10 still can be used but with a slightly different method. A lure will be attached to the fishing line 34, and the drag loosened on the reel 31. The lure will be placed down into the elongated tube 22 until it is stopped at the valve 16. The user will then pour about 1 quart of water into the tube 22. The tank 12 will be filled with air and the air released by opening the valve 16. At that point, the air then pushes the water and lure up the elongated tube 22 and out into the ocean.

As is known to those of ordinary skill in the art, a popping cork can be constructed of materials such as wood, metal, plastic, wax, etc. The popping cork is a cylinder in shape, with an eyelet on each end. The fisherman attaches the end of the fishing line 34 to one end of the popping cork. The other end of the popping cork attaches to the leader. The leader will have a length up to 4 feet and have any type of plastic bait or lure attached at its end. The lure, leader and popping cork will be placed in the elongated tube 22 and launched the same as above. The popping cork is weighted but does float. Upon retrieval of popping cork and lure, the popping cork causes a disturbance in the water to attract fish and then fish will bite on the lure which is located behind the cork.

Those of ordinary skill in the art will recognize that many obvious modifications may be made to the foregoing embodiment without departing from the spirit or scope of the present invention as set forth in the appended claims.

What is claimed is:

1) A device to propel a baited fishing hook, weighted lure or popping cork that is attached to a fishing rod and reel comprising:
a) A storage vessel for compressed air and comprising an outlet port;
b) A valve connected to the outlet port which is adapted to release the compressed gas from the storage vessel when the valve is opened; and
c) An elongated tube connected to the outlet port that is adapted to receive the baited fishing hook;
wherein upon opening of the valve the baited fishing hook, weighted lure or popping cork is propelled from the elongated tube.

2) The device of claim 1 wherein the storage vessel is fitted with a refill port so that the vessel can be refilled with compressed air.

3) The device of claim 1 wherein the device comprises means to vary the pressure and rate of release of the compressed gas from the storage vessel.

4) The device of claim 1 wherein the elongated tube is further adapted to receive a baited hook that is frozen in a block of ice.

5) The device of claim 1 wherein the elongated tube further comprises a perforated sound suppression fitting on an end thereof.

6) A combination fishing rod, fishing reel and device for propelling a baited fishing hook, weighted lure or popping cork attached to fishing line on the fishing reel wherein the device for propelling the baited hook comprises:
a) A storage vessel for compressed air and comprising an outlet port;
b) A valve connected to the outlet port which is adapted to release the compressed air from the storage vessel when the valve is opened; and
c) An elongated tube connected to the outlet port that is adapted to receive the baited fishing hook;
wherein upon opening of the valve the baited fishing hook, weighted lure or popping cork is propelled from the elongated tube.

7) The combination of claim 6 wherein the storage vessel is fitted with a refill port so that the vessel can be refilled with compressed air.

8) The combination of claim 6 wherein the device comprises means to vary the pressure and rate of release of the compressed gas from the storage vessel.

9) The combination of claim 6 wherein the elongated tube is further adapted to receive a baited hook that is frozen in a block of ice.

10) The combination of claim 6 wherein the elongated tube further comprises a perforated sound suppression fitting on an end thereof.

11) A method for propelling a baited fishing hook into the surf comprising the steps of
a) Disposing the baited hook into a container with water therein;
b) Freezing the water and baited hook in the container;
c) Removing the frozen water with baited hook from the container;
d) Connecting the frozen baited hook to a fishing line connected to a fishing rod and reel;
e) Providing a device to propel the frozen baited hook comprising the following;
(i) A storage vessel for compressed air and further comprising an outlet port;
(ii) A valve connected to the outlet port which is adapted to release the compressed air from the storage vessel when the valve is opened;
(iii) An elongated tube connected to the outlet port that is adapted to receive the baited fishing hook;
f) Placing the frozen baited hook into the elongated tube;
g) Opening the valve to release the compressed air and thereby propelling the frozen baited hook into the surf for fishing.
